(19) United States
(12) Patent Application Publication
(10) Pub. No.: US 2026/0097250 A1
(43) Pub. Date: Apr. 9, 2026

(54) THERMAL DESTRUCTION RESERVOIR SYSTEM

(71) Applicant: Southwest Research Institute, San Antonio, TX (US)

(72) Inventors: Kyle C. FERNANDEZ, San Antonio, TX (US); Matthew S. BLAIS, Lake Hills, TX (US)

(21) Appl. No.: 18/910,323

(22) Filed: Oct. 9, 2024

(51) Int. Cl. A62D 3/40; C08J 7/05; C08K 3/08; C08K 3/16

(52) U.S. Cl. CPC A62D 3/40; C08J 7/05; C08K 3/08; C08K 3/16; C08J 2331/04; C08K 2003/0856

(57) ABSTRACT

A thermal destruction reservoir system and a method of using the same to thermally destroy certain chemical and/or biological materials. The reservoir relies upon the use of a sheet comprising potassium perchlorate and iron dispersed in a polymeric binder.

### FIELD

The present disclosure is generally directed to a thermal destruction reservoir system and a method of using the same to thermally destroy certain chemical and/or biological materials.

### BACKGROUND

Certain chemical and/or biological materials can be harmful and the risk they pose to the surrounding environment and/or people, animals, or objects within that environment may need to be mitigated. One way to mitigate the risk posed by various chemical and/or biological materials is by thermally decomposing the chemical and/or biological materials. Thermal decomposition is a chemical process where thermal energy is used to break the chemical bonds holding together molecules. By exposing the chemical and/or biological materials to heat, the bonds holding together the molecules of the chemical or biological material are broken. Thus, the heating of the chemical and/or biological material results in the breakdown of the original molecules into smaller compounds and/or elements.

Additionally, chemical and/or biological materials may often need to be destroyed at remote locations where large infrastructure would not be feasible. Thus, there is a need for a thermal destruction reservoir such that it can be transported to desired remote locations.

### SUMMARY

A thermal destruction reservoir, comprising an upper and lower section having one or a plurality of wall portions, wherein the upper and lower section each include one or more perimeter mating surfaces, and an internal volume encased by the upper and lower sections when said perimeter mating surfaces are engaged to one another. The one or plurality of wall portions have a clay coating providing an inner surface in said reservoir and at least one sheet comprising potassium perchlorate and iron dispersed in a polymeric binder located within the reservoir internal volume.

A thermal destruction reservoir comprising an upper and lower section having one or a plurality of wall portions wherein the upper and lower section each include one or more perimeter mating surfaces and an internal volume encased by the upper and lower sections when the perimeter mating surfaces are engaged to one another. At least one sheet comprising potassium perchlorate and iron dispersed in a polymeric binder is located within the reservoir internal volume wherein the binder comprises poly(vinyl acetate) and poly(vinyl acetate)-poly(vinyl alcohol) copolymer, the potassium perchlorate is present in the sheet at a level of 69.0% (wt.) or higher, iron is present at a level of 15.0% (wt.)+/−5.0% (wt.) and the polymeric binder is present at a level of 16.0% (wt.)+/−5.0% (wt.).

A method of thermal destruction of selected chemical and/or biological materials comprising providing a thermal destruction reservoir comprising an upper and lower section having one or a plurality of wall portions wherein the upper and lower section each include one or more perimeter mating surfaces and an internal volume encased by the upper and lower sections when said perimeter mating surfaces are engaged to one another. One then forms a sheet by combining potassium perchlorate, iron powder and polymer binder at a temperature of less than or equal to 35° C. and positions the sheet within the internal volume of the thermal destruction reservoir.

### BRIEF DESCRIPTION OF THE DRAWINGS

The above-mentioned and other features of this disclosure, and the manner of attaining them, will become more apparent and better understood by reference to the following description of embodiments described herein taken in conjunction with the accompanying drawings, wherein:

FIG. 1 depicts an embodiment of a portable thermal destruction reservoir consistent with the present disclosure;

FIG. 2 depicts a cross-sectional view of the embodiment of the portable thermal destruction reservoir shown FIG. 1 consistent with the present disclosure;

FIG. 3 depicts an enlarged portion of the cross-sectional view of FIG. 2 depicting a clip over a pair of aligned top and bottom perimeter mating surfaces of the embodiment of the portable thermal destruction reservoir shown in FIG. 1, consistent with the present disclosure;

FIG. 4 depicts a perspective view of a portion of a clip installed over a pair of aligned top and bottom perimeter mating surfaces of the portable thermal destruction reservoir shown in FIG. 1, consistent with the present disclosure;

FIG. 5 depicts perspective view of an embodiment of the secondary containment and filtration bag, consistent with the present disclosure;

FIG. 6 illustrates a preferred method of producing a potassium perchlorate sheet, consistent with the present disclosure;

FIG. 7 depicts a diagram of the method of thermally destroying liquid chemical and/or biological materials using a portable thermal destruction reservoir system, consistent with the present disclosure;

FIG. 8 is a graph of the recorded temperature within the internal volume of the thermal destruction reservoir described herein monitored using the temperatures sensor over a period of time;

FIG. 9 provides another view of a preferred thermal destruction reservoir;

FIG. 10 provides a more detailed view of the closing hardware illustrated in FIG. 9; and

FIG. 11 is an open view of the thermal destruction chamber of FIG. 9.

### DETAILED DESCRIPTION

The present disclosure is not limited in its application to the details of construction and the arrangement of components set forth in the following description or illustrated in the drawings. The examples described herein may be capable of other embodiments and of being practiced or being carried out in various ways. Also, it may be appreciated that the phraseology and terminology used herein is for the purpose of description and should not be regarded as limiting as such may be understood by one of skill in the art. Throughout the present description, like reference characters may indicate like structure throughout the several views, and such structure need not be separately discussed. Furthermore, any particular feature(s) of a particular exemplary embodiment may be equally applied to any other exemplary embodiment(s) of this specification as suitable. In other words, features between the various exemplary embodiments described herein are interchangeable, and not exclusive.

The present disclosure is generally directed to a thermal destruction reservoir system configured to thermally decompose certain hazardous chemical and/or biological materials. More specifically, the present disclosure is directed to a thermal destruction reservoir system comprising a thermal destruction reservoir that makes use of potassium perchlorate (KClO₄) and iron (Fe) dispersed in a polymeric binder and preferably configured in the form of a sheet. The KClO₄ is preferably present in the sheet at a level of 69.0% (wt.) or higher, Fe is present at a preferred level of 15.0% (wt.)+/−5.0% (wt.) and the polymeric binder is present at a preferred level of 16.0% (wt.)+/−5.0% (wt.), where the total weight percent of components in the sheet add up to 100% (wt.). The Fe itself is preferably sourced from sieved Fe powder having a particle size of 20.0 microns. Accordingly, the Fe powder present preferably has a particle size in the range of 5.0 microns to 20.0 microns.

The polymeric binder is preferably sourced from a liquid polymer, more specifically a polymeric emulsion wherein the polymer is emulsified in the presence of water. A preferred liquid polymer herein includes poly(vinyl acetate) and poly(vinyl acetate)-poly(vinyl alcohol) copolymer in the presence of water. Such liquid polymer is preferably sourced from Titebond™.

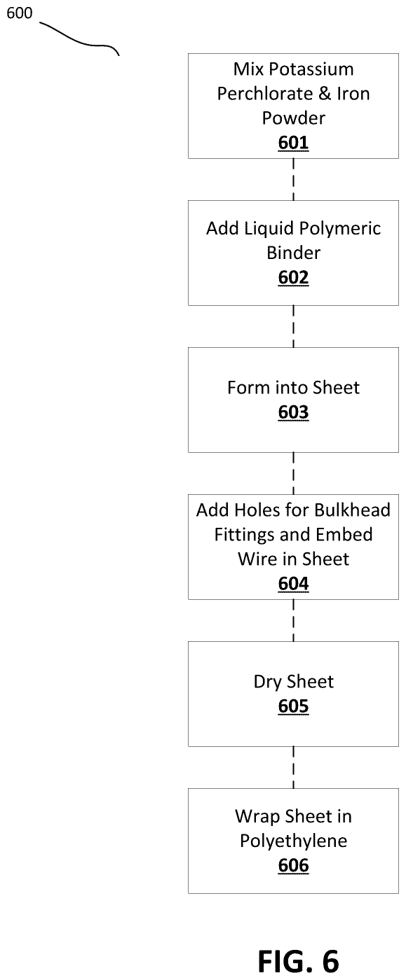

The sheet is preferably prepared by combining the KClO₄ with the Fe powder liquid polymer binder is added and the mixture is then shaped into sheet form. Preferably, one may first mix the KClO4 and Fe powder and then introduce the polymer binder. In either case, such mixing can be advantageously carried out at a temperature of less than or equal to 35° C. (≤35° C.) or even more preferably ≤30° C. or even ≤25° C. In addition, preferably, the sheet preparation can be carried out at about room temperature (e.g., at 20° C. to 30° C.), which thereby avoids the use of heating and provides a relatively safer handling of the KClO₄ ingredient. One preferred method for preparing the sheet is illustrated in FIG. 6. As shown therein, One first mixes at 601 the potassium perchlorate (KClO₄) with Fe powder. This then is followed by addition of the liquid polymeric binder at 602 followed by formation into a sheet at preferred temperatures of 20° C. to 30° C. One may then at 603 add holes for bulkhead fitting and embed wire in the sheet and then dry the sheet at 605 followed by wrapping of the sheet in a polymeric material at 606, such as polyethylene..

The sheet so formed containing KClO₄ along with Fe in the presence of polymeric binder has a preferred thickness in the range of 1.0 cm to 5.0 cm, including all values and increments therein. Accordingly, the sheet may have a thickness of 1.1 cm, 1.2 cm, 1.3 cm, 1.4 cm, 1.5 cm, 1.6 cm, 1.7 cm, 1.8 cm, 1.9 cm, 2.0 cm, 2.1 cm, 2.2 cm, 2.3 cm, 2.4 cm, 2.5 cm, 2.6 cm, 2.7 cm, 2.8 cm, 2.9 cm, 3.0 cm, 3.1 cm, 3.2 cm, 3.3 cm, 3.4 cm, 3.5 cm, 3.6 cm, 3.7 cm, 3.8 cm, 3.9 cm, 4.0 cm, 4.1 cm, 4.2 cm, 4.3 cm, 4.4 cm, 4.5 cm, 4.6 cm, 4.7 cm, 4.8 cm, 4.9 cm, or 5.0 cm.

During formation of the sheet, it is preferably shaped to be indexed along a clay lining of an inner wall surface portion of a thermal destruction reservoir, described further herein. The sheet may also preferably include one or a plurality of round openings to align and engage with placement pins present in the inner wall portion. In addition, the sheet is preferably configured to include NiCr wire embedded into the surface of the sheet, for electrical ignition. In addition, preferably, the sheet containing KClO₄/Fe powder and polymeric binder may be wrapped in polyethylene film or poly(vinylidene chloride) film and stored before installation into the thermal destruction reservoir. The sheet may also be wrapped in aluminum foil.

The thermal destruction reservoir herein preferably comprises a top and bottom section, one or more clips, and one or more of the KClO₄/Fe powder and polymer binder sheets disclosed herein, having an electrical ignition system. The top and bottom sections may each comprise one or more walls, define an internal volume, one or more perimeter mating surfaces, and tabs extending beyond said one or more perimeter mating surfaces. The panels may be configured to align along their respective perimeter mating surfaces to form the internal volume encased by the panel walls.

The internal volume of the thermal destruction reservoir may preferably be in the range of 1.0 to 10.0 liters. The thermal destruction reservoir may preferably be configured to include one or a plurality of the aforementioned KClO₄/Fe powder and polymer binder sheets, such as 1-10 sheets. The dimensions and/or geometry of the internal volume of the thermal destruction reservoir may be determined based on the quantity and/or identity of the liquid chemical and/or biological material the thermal destruction reservoir is intended to destroy.

The clips of the thermal destruction reservoir may be configured to slide over a pair of aligned perimeter mating surfaces of the upper and lower sections of the reservoir. There may preferably be one or more clips installed on each pair of aligned perimeter mating surfaces of the thermal destruction reservoir. For example, there may be a single clip for each aligned perimeter mating surface that extends along the full length or a portion of the aligned mating surface. By way of another example, there may be more than one clip along the full length of each aligned perimeter mating surface such that the combination of clips on the perimeter mating surfaces extends along the full length or a portion of the perimeter mating surfaces. Preferably, there may be a quantity of clips for each aligned perimeter mating surface in the range of 1 to 10, more preferably in the range of 1 to 3.

The clip(s) may be configured to apply a compressive force directly on the aligned perimeter mating surfaces and/or to apply a compressive force on the tabs extending beyond the perimeter mating surfaces such that the compressive force is transferred to the aligned mating surfaces through the tabs. The compressive force on the aligned perimeter mating surfaces may be sufficient to hold the aligned perimeter mating surfaces together against the force caused by pressure increases within the internal volume during thermal decomposition of the selected chemical and/or biological materials within the internal volume. The compressive force on the aligned perimeter mating surfaces (e.g. around 2500 psi) preferably allows contents within the internal volume of the thermal decomposition reservoir to escape upon reaching a pressure above or equal to 5.0 psi.

When installed over the aligned perimeter mating surfaces of the top and bottom sections of the thermal destruction reservoir, the clip(s) may obscure at least a portion of the aligned perimeter mating surfaces from the environment external to the thermal destruction reservoir. The clip(s) may preferably include one or more openings such that, where the clips obscure at least a portion of the aligned perimeter mating surface from the external environment, any contents of the internal volume which may escape through the aligned perimeter mating surface may further escape through openings of the clip into the environment external to the thermal destruction reservoir.

The tabs of the upper and lower sections may preferably extend beyond the perimeter mating surfaces by a distance in the range of 0.1 inches to 2 inches, more preferably in the range of 0.5 inches to 1 inch. The tabs may preferably extend beyond the perimeter mating surfaces at an angle relative to the perimeter mating surface in the range of 0 degrees to 100 degrees where at 0 degrees, the tab would extend outward from the panel mating surface such that the tab and panel mating surface would be coplanar. More preferably, the tabs may extend beyond the perimeter mating surface at an angle in the range of 20 degrees to 80 degrees.

The internal volume of the thermal destruction reservoir may additionally include a container/bladder for the liquid chemical and/or biological material. The container may preferably be comprised of a polymeric material. The container may additionally include a feed tube connecting a volume within the container with an external source of liquid chemical and/or biological materials such that the material can be injected into the container from outside the thermal destruction reservoir without having to remove the clips from the mating surfaces of the panels.

The upper and lower sections may be preferably comprised of sheet metal, more preferably stainless-steel sheets. The upper and lower sections may be formed by bending, rolling, punching, laser cutting, hydroforming, forging, and/or extruding. The one or more walls of the upper and lower section further include an inner surface comprising a clay coating or liner. Clay is a general reference to a composition composed of silica (SiO₂), alumina (Al₂O₃) and water (H₂O). The clay may therefore preferably comprise ceramic modelling clay, composed of clay minerals, such as kaolin, Al₂Si₂O₅(OH)₄, that may also include iron, magnesium, alkali metals, or alkaline earths. The composition, thickness and heat transfer properties of the clay may be determined based on the chemical and/or biological material the thermal destruction reservoir is intended to destroy and the thermal load that would be imposed on the sheet metal components of the reservoir.

Further, the thermal destruction reservoir may include one or more fittings (e.g., bulkhead fittings). The fittings may be located between one or more of the aligned panel mating surfaces and/or in the panels of the thermal destruction reservoir. The fitting(s) may provide a pathway for connections between the electrical ignition system in the internal volume and the environment external to the thermal destruction reservoir. Additionally, a fitting may provide a pathway for connections between a measurement device placed within the internal volume and the environment external to the thermal destruction reservoir. A measurement device placed within the internal volume of the thermal destruction reservoir may preferably be configured to monitor conditions within the internal volume, for example but not limited to temperature and/or pressure. The measurement device within the internal volume may preferably comprise an optical sensor (e.g., infrared, camera), thermal sensor, piezoelectric sensor, strain gauge, and/or any other type of sensor.

Once the perimeter mating surfaces of the upper and lower section are aligned and the clips are applied thereto, the thermal destruction reservoir may preferably be placed within a secondary containment and filtration bag. The secondary containment and filtration bag may be configured to capture and/or filter contents of the thermal destruction reservoir which may escape through the aligned panel mating surfaces. The dimensions of the secondary containment and filtration bag may be determined by the size and shape of the thermal destruction reservoir such that the thermal destruction reservoir may fit within the secondary containment and filtration bag. Additionally, the secondary containment and filtration bag may include one or more fittings (e.g., bulkhead fittings) configured provide pathway for the connections through the fittings in the thermal destruction reservoir and/or for the connections between components within the secondary containment and filtration bag and components in the environment external to the secondary containment and filtration bag. This fitting in the secondary containment and filtration bag may preferably allow control of the electrical ignition system embedded in the KClO₄/Fe powder and polymer binder sheet(s) from outside of the secondary containment and filtration bag.

The secondary containment and filtration bag may preferably include a sealable opening configured to allow the thermal destruction reservoir to pass through into the bag and be sealed inside the bag. The secondary containment and filtration bag may preferably be comprised of thermite. One example of a secondary containment and filtration bag includes what is disclosed in U.S. Pat. No. 10,677,460, entitled Thermite Bag For Chemical/Biological Agent Munition And Hazardous Waste Disposal System, whose teachings are incorporated by reference.

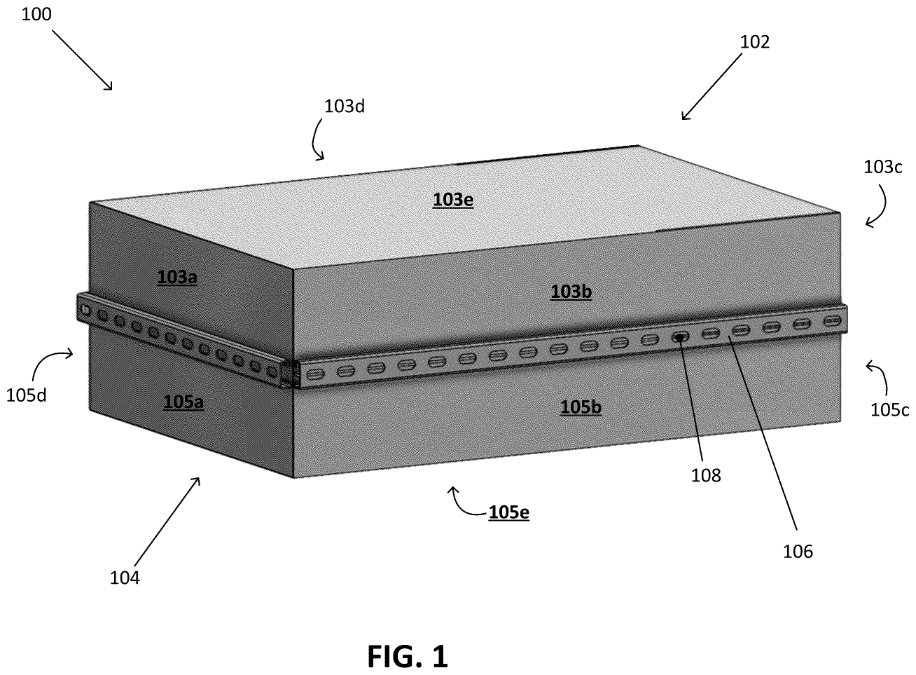

An embodiment of a preferred thermal destruction reservoir 100 is depicted in FIG. 1. The thermal destruction reservoir 100 includes top or upper section 102 and bottom or lower section 104. Top section 102 includes one or a plurality of wall portions, e.g., five walls 103a-e and the bottom section 104 includes a plurality of walls, e.g., five walls 105a-e. Walls 103a-e and 105a-e have preferably flat wall profiles. Thermal destruction reservoir 100 also includes clips 106. The clips 106 as shown have one or a plurality of openings 108 through which the contents of the internal volume (i.e., the products of the thermal decomposition such as vent gases or fumes) may escape through the aligned mating surfaces of the panels.

While the thermal destruction reservoir 100 depicted in FIG. 1 may be described as rectangular prism, the thermal destruction reservoir as disclosed herein may have any three-dimensional shape including but not limited to a cube, a sphere, a cylinder, a pyramid, a cone, a triangular prism, etc. The thermal destruction reservoir may have a length, width, and height. The length of the thermal destruction reservoir may be in the range of 0.5 ft to 10 ft, more preferably in the range of 0.5 ft to 5 ft, including all values and increments therein. The width of the thermal destruction reservoir may preferably be in the range of 0.5 ft to 10 ft, more preferably in the range of 0.5 ft to 5 ft, including all values and increments therein. The height of the thermal destruction reservoir may preferably be in the range of 0.5 ft to 10 ft, more preferably in the range of 0.5 ft to 5 ft, including all values and increments therein.

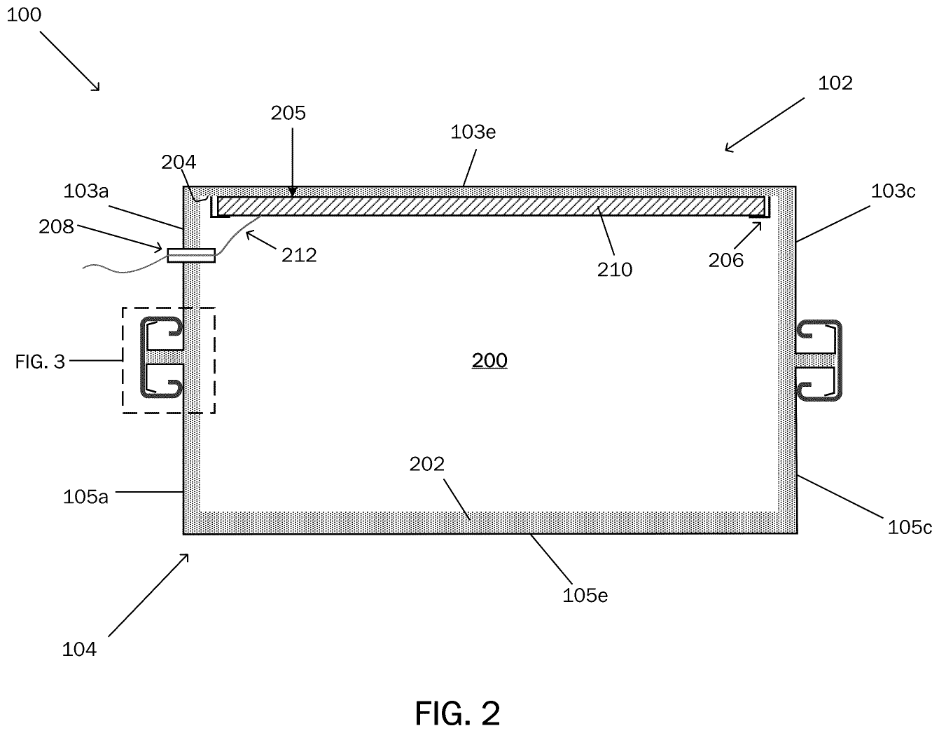

FIG. 2 depicts a cross section of the preferred embodiment of the thermal destruction reservoir 100 depicted in FIG. 1. As seen in FIG. 2, the walls 105a-e, 103a-e encase internal volume 200 include an internal clay lining or coating 202 along the reservoir's inner surfaces. Preferably, the internal clay lining generally has a thickness in the range of 0.25 inches to 2.0 inches, more preferably 0.25 inches to 1.0 inches. As shown in FIG. 2, preferably, the clay lining or coating has relatively reduced thickness on the upper section 102 where there are indexing features or brackets 206 that serve to retain the KClO₄/Fe powder and polymer binder sheet 210 in contact with an inner surface 204 of the clay lining. The relatively reduced thickness of the clay lining at the location where there is a retained sheet 210 is in the range of 0.20 inches to 0.30 inches. The thickness of the clay lining at those locations where there is no retained sheet 210, is preferably in the range of 0.40 inches to 0.70 inches.

More specifically, the KClO₄/Fe powder and polymer binder sheet 210 itself has a surface 205 where all or a portion of such sheet surface 205 is preferably in contact with the inner surface 204 of the clay lining. However, in the broad context of the present invention, the sheet 210 may be spaced apart from the inner surface of the clay lining.

Preferably then, for a given cross-sectional surface area of the KClO₄/Fe powder and polymer binder sheet 210, it is preferred that 50% or more such cross-sectional surface area is in contact with the inner surface 204 of the clay lining. Accordingly, it is preferable that at least 50% to 100% of the surface 205 of sheet 210 is in contact with the inner surface 204 of the clay lining 202. More preferably, 60% to 100%, 70% to 100%, 80% to 100%, or 90% to 100% of the surface 205 of sheet 210 is in contact with the inner surface 204 of the clay lining 202.

The KClO₄/Fe powder and polymer binder sheet 210 preferably includes an electrical ignition system 212 embedded therein. One or more fittings 208 in panel 104 may provide pathways for the connections between the electrical ignition system 212 in internal volume 200 and the environment external to the thermal destruction reservoir. Though the embodiment depicted in FIG. 2 includes only one potassium perchlorate sheet, the thermal destruction reservoir disclosed herein may include more than one KClO₄/Fe powder and polymer binder sheet held onto another internal clay surface by additional indexing features. For example, the thermal destruction reservoir may preferably contain 1-10 sheets, and each sheet may then be indexed proximate to or onto the inner clay surfaces or inner walls of the thermal destruction reservoir.

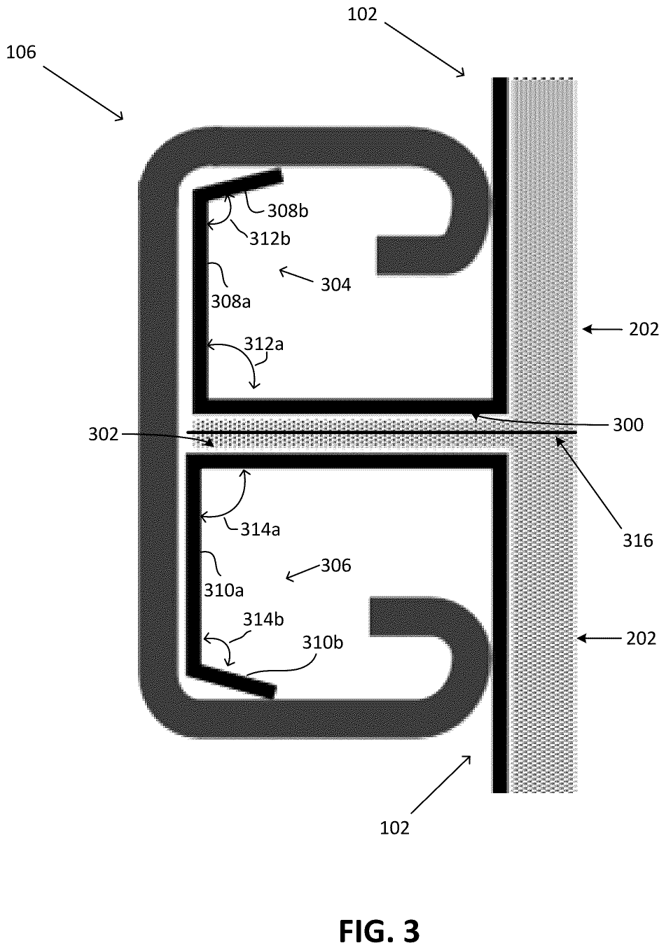

FIG. 3 depicts a section view of the clip 106 installed and positioned over the perimeter mating surfaces 300, 302 of upper and lower sections 102, 104, which clips operate to mechanically retain the perimeter mating surface in contact with one another. When the perimeter mating surfaces 300 and 302 are aligned and engaged to one another, the upper and lower sections 102 and 104 define internal volume 200 (see again, FIG. 2).

As can be seen, the perimeter mating surfaces of the upper and lower sections 102 and 104 are preferably covered with clay lining 202 which then provides impinging clay lining surfaces shown generally at 316. Tabs 304, 306 extend beyond the perimeter mating surfaces 300, 302, respectively. Tabs 304, 306 each include first segments 308a, 310a, respectively, and second segments 308b, 310b, respectively. Though the tabs 304, 306 depicted in FIG. 3 each have two segments, tabs consistent with the present invention may include a quantity of segments in the range of 1 to 5, more preferably 1 to 3. Each segment 308a, 308b, 310a, 310b may have a length in the range of 0.1 inches to 2 inches, more preferably in the range of 0.25 inches to 1 inch. Additionally, each segment may have a relative angle 312a, 312b, 314a, 314b between the segments 308a, 308b, 310a, 310b. The angles 312a, 312b, 314a, 314b between the segments 308a, 308b, 310a, 310b may preferably be in the range of 0° to 180°, more preferably in the range of 45° to 110°. Clip 106 may be installed over panel mating portions 300 and 302. As noted, the perimeter mating portions 300, 302 may also include impinging clay lining surfaces 316. Clip 106 applies a compressive force on tabs 220 and 222 which is then transferred through the tabs to the aligned panel mating portions 216 and 218 respectively.

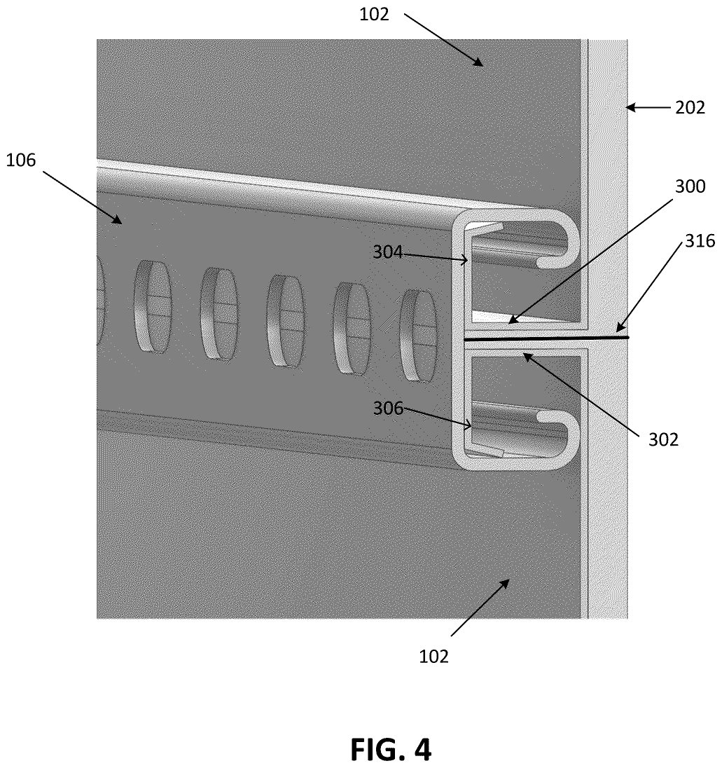

FIG. 4 depicts a perspective section view of clip 106 installed over perimeter mating surfaces 300, 302 and tabs 304, 306 of upper and lower sections 102, 104.

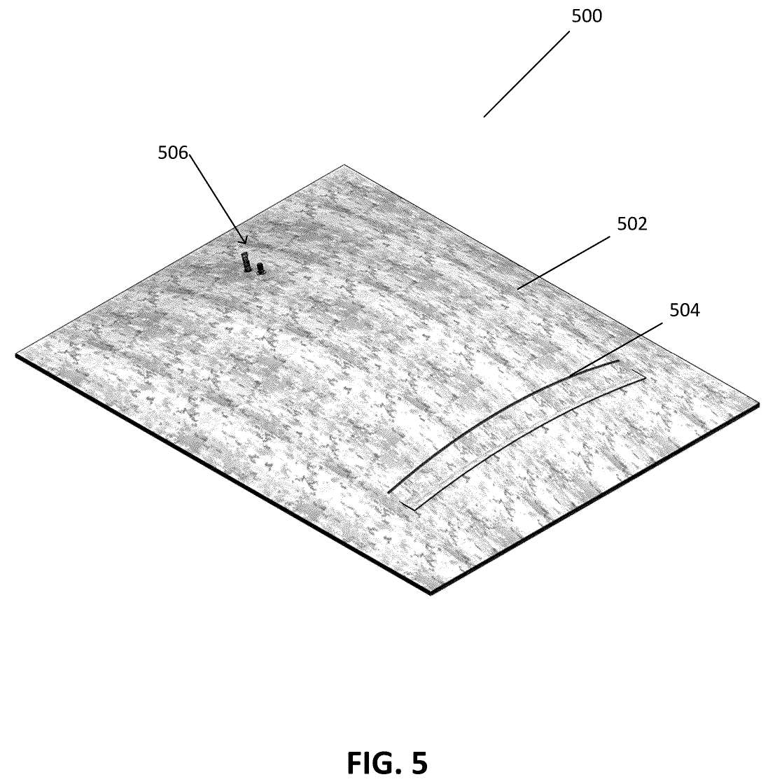

FIG. 5 depicts an embodiment regarding the optional use of a secondary containment and filtration bag 500 for the thermal destruction reservoir system. The secondary containment and filtration bag 500 may include a bag wall 502 and a sealable opening 504 configured to allow a thermal destruction reservoir to be inserted through the sealable opening 504 which may then be sealed to contain the thermal destruction reservoir within the bag wall 502. Additionally, the secondary containment and filtration bag 500 may preferably include one or more fittings (e.g., bulkhead fittings) to provide pathways for the connections to be made through the bag wall 502 (e.g., the electrical ignition system of the thermal destruction reservoir, electrical connections to any sensors housed within the secondary containment and filtration bag 500 and/or the thermal destruction reservoir).

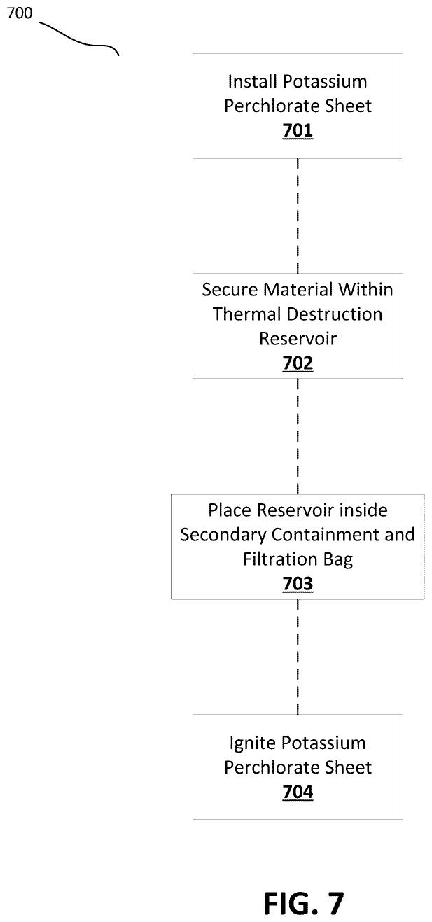

Another embodiment of the present disclosure is a method of thermally decomposing liquid chemical and/or biological materials. One preferred embodiment of this method is depicted in FIG. 7. The method depicted in FIG. 7 may preferably use a thermal destruction reservoir system as disclosed herein. Step 701 may comprise installing a KClO₄/Fe powder and polymer binder sheet on an indexing surface secured by one or more indexing features of a thermal destruction reservoir of the thermal destruction reservoir system. Step 701 may additionally include inserting an electric ignition system embedded in the KClO₄/Fe powder and polymer binder sheet through one or more fittings in the thermal destruction reservoir panel(s) so as to provide a connection between the sheet within the thermal destruction reservoir with the environment outside the panels of the thermal destruction reservoir.

Step 702 may preferably comprise securing the liquid chemical and/or biological material within the thermal destruction reservoir. More specifically, step 702 may preferably include inserting the liquid chemical and/or biological material into the thermal destruction reservoir, aligning the mating surfaces of each panel of the thermal destruction reservoir, and applying the clip(s) to each pair of aligned panel mating surfaces. As discussed above, the thermal destruction reservoir may preferably include a container within the internal volume of the thermal destruction reservoir. The container may include a feed tube which may be fed through a liquid fill port of the thermal destruction reservoir such that the container may be filled from the outside of the thermal destruction reservoir after the clips have been installed on the aligned panel mating surface(s).

Further, step 702 may include inserting electrical connections through the pathway(s) provided by the one or more fittings located between one or more of the aligned panel mating surfaces and/or in the panels of the thermal destruction reservoir. The electrical connections may include the connection between the electrical ignition system embedded in the KClO₄/Fe powder and polymer binder sheets sheet and a device within the external environment (e.g., a controller, monitor, etc.) and/or the connection between a measurement device placed within the internal volume of the thermal destruction reservoir and a device within the external environment (e.g., a controller, monitor, etc.). As discussed above, the measurement device placed within the internal volume of the thermal destruction reservoir may be configured to monitor conditions within the internal volume, for example but not limited to temperature and/or pressure.

Step 703 comprises placing the thermal destruction reservoir in the secondary containment and filtration bag. As noted above, this may include a thermite type bag. Step 703 may include making electrical connections through the secondary containment and filtration bag such that the connection may extend into the environment external to the entire thermal destruction reservoir system. Step 703 may include sealing the secondary containment and filtration bag after the thermal destruction reservoir has been placed within it.

Step 704 may comprise igniting the KClO₄/Fe powder and polymer binder sheets sheet using the electrical ignition system embedded therein. Upon igniting the sheet, the thermal destruction of the liquid chemical and/or biological material may begin. After a destruction time has passed, the secondary containment and filtration bag may be unsealed and the clips may be removed from the aligned panel mating surface such that the panels may be separated. The destruction time may preferably be in the range of 20 seconds to 180 seconds, more preferably in the range of 20 seconds to 50 seconds.

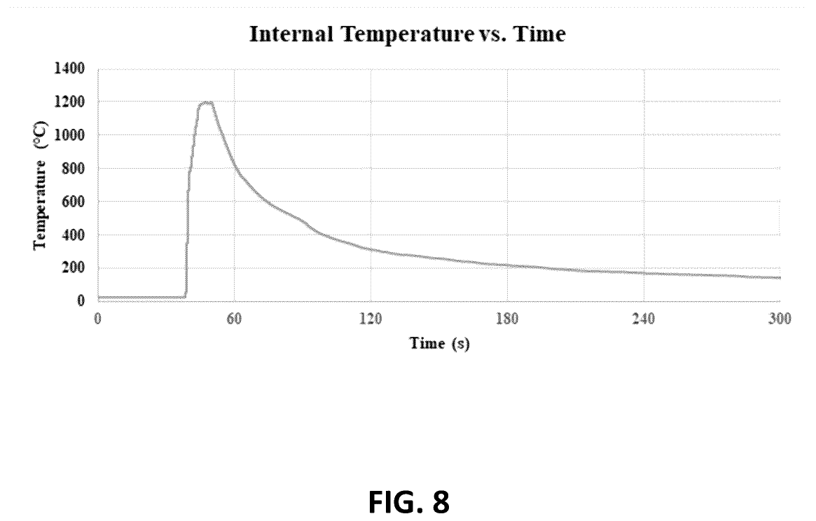

The temperature within the internal volume of the thermal destruction reservoir as described herein was monitored using a temperatures sensor. The results of such monitoring are presented in FIG. 8. As shown, the ignition of the KClO₄/Fe powder and polymer binder sheet began at approximately 40 seconds and reached the maximum internal temperature of approximately 1200° C. after approximately 5 seconds. The internal temperature remained at the maximum temperature for approximately 2 seconds. After two seconds, the temperature exponentially decayed.

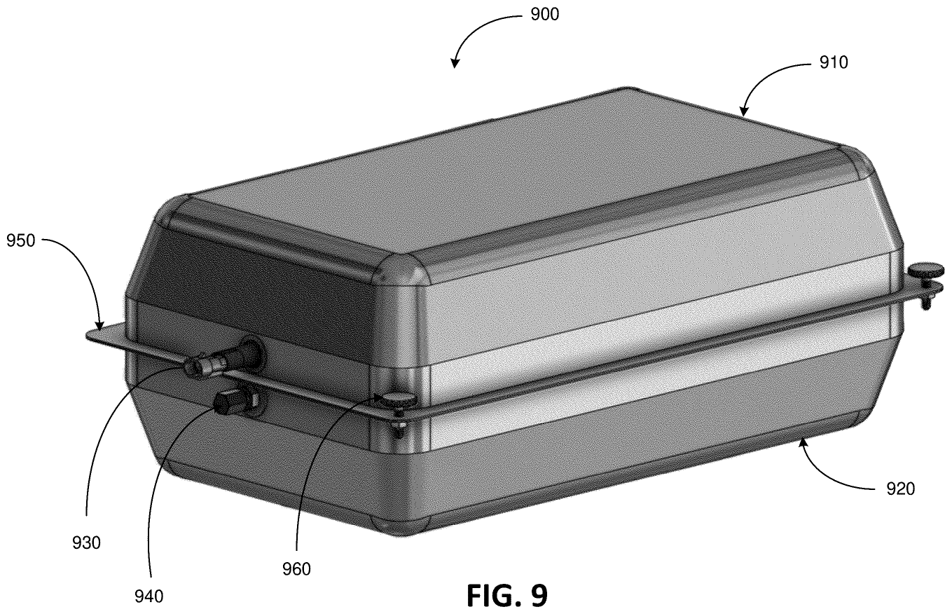

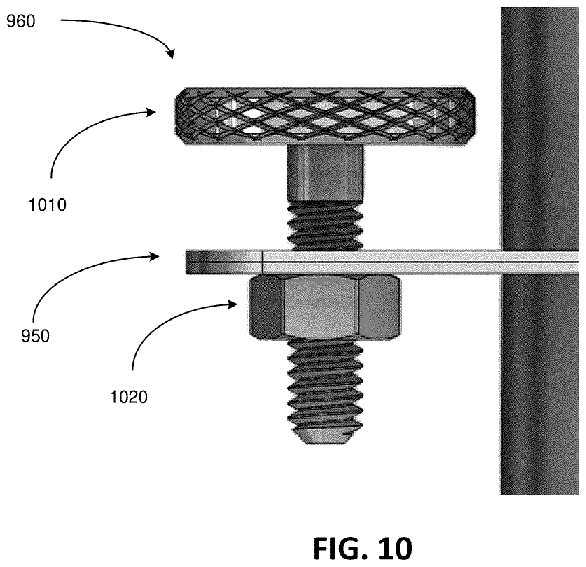

FIG. 9 provides another view of a thermal destruction reservoir herein. In this preferred embodiment the thermal destruction reservoir 900 again has upper section 910 and lower section 920. At 930 can be seen the fitting in the reservoir providing for introduction of the electrical ignition system that is then preferably in contact with the KClO₄/Fe powder and polymer binder sheet described herein. A liquid fill port is shown at 940 which will then allow one to feed in the liquid chemical or biological material for destruction. Additionally, shown at 950 are the perimeter mating surfaces of the upper and lower sections. In lieu of clips, one can preferably utilize the closing hardware shown at 960. A more detailed view of the closing hardware 960 is illustrated in FIG. 10. As can be seen, the closing hardware component 960 preferably includes screw 1010 and nut 1020 which screw 1010 passes through the perimeter mating surfaces 950. Preferably, the screw 1010 can be hand tightened. Accordingly, one of screw/nut closing hardware components may be employed.

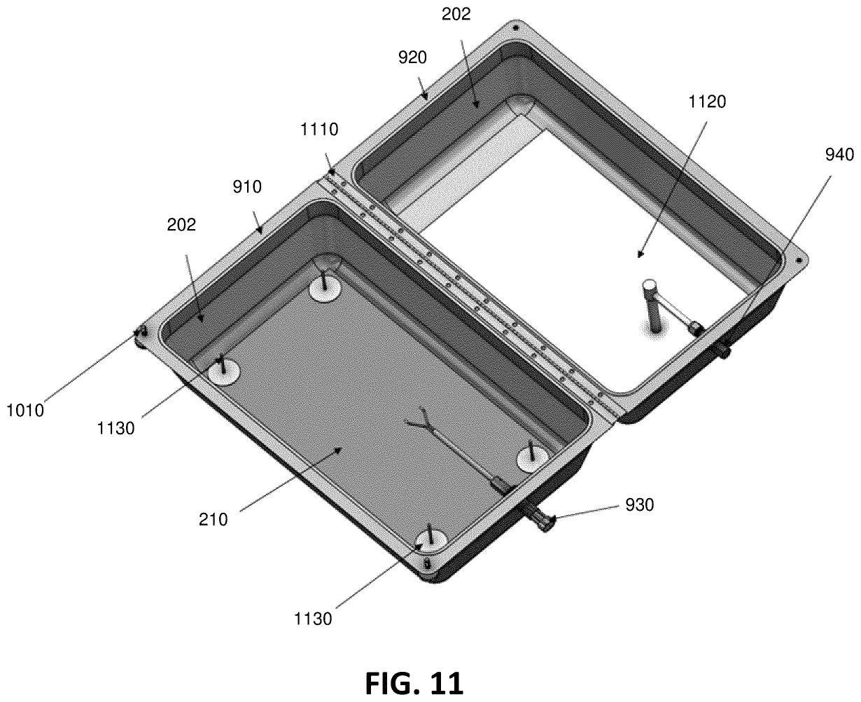

FIG. 11 is an open view of the thermal destruction chamber of FIG. 9. As can seen, the chamber has upper section 910 and lower section 920 that are preferably joined together via hinge 1010. At 202 can be seen the clay lining or coating and at 1120 is the container/bladder for receipt of the liquid chemical and/or biological material for destruction, introduced through fill port 940. At 210 can be seen the KClO₄/Fe powder and polymer binder sheet that is in contact with the electrical ignition system 930. One can also see at 1130 the preferred use of welded pins and washers to assist in retaining the KClO₄/Fe powder and polymer binder sheet. The closing hardware screw can be seen at 1010.

The foregoing description of example embodiments has been presented for the purposes of illustration and description. It is not intended to be exhaustive or to limit the present disclosure to the precise forms disclosed. Many modifications and variations are possible in light of this disclosure. It is intended that the scope of the present disclosure be limited not by this detailed description, but rather by the claims appended hereto.

Unless otherwise stated, use of the word “substantially” may be construed to include a precise relationship, condition, arrangement, orientation, and/or other characteristic, and deviations thereof as understood by one of ordinary skill in the art, to the extent that such deviations do not materially affect the disclosed methods and systems. The terms “connected” or “coupled” as used herein is a relative term and does not require a direct physical connection, unless otherwise stated.

Throughout the entirety of the present disclosure, use of the articles “a” and/or “an” and/or “the” to modify a noun may be understood to be used for convenience and to include one, or more than one, of the modified noun, unless otherwise specifically stated. The terms “comprising,” “including,” and “having” are intended to be inclusive and mean that there may be additional elements other than the listed elements.

Although the methods and systems have been described relative to a specific embodiment thereof, they are not so limited. Obviously, many modifications and variations may become apparent in light of the above teachings. Many additional changes in the details, materials, and arrangement of parts, herein described and illustrated, may be made by those skilled in the art.

What is claimed is:

1. A thermal destruction reservoir, comprising:
an upper and lower section having one or a plurality of wall portions, wherein said upper and lower section each include one or more perimeter mating surfaces and an internal volume encased by said upper and lower sections when said perimeter mating surfaces are engaged to one another;
said one or plurality of wall portions having a clay coating providing an inner surface in said reservoir;
at least one sheet comprising potassium perchlorate and iron dispersed in a polymeric binder located within said reservoir internal volume.

2. The thermal destruction reservoir of claim 1, wherein said sheet has a surface and all or a portion of said sheet surface is in contact with said clay coating inner surface.

3. The thermal destruction reservoir of claim 1, wherein an electrical ignition system is embedded in said sheet.

4. The thermal destruction reservoir of claim 1, wherein said polymer binder comprises poly(vinyl acetate) and poly(vinyl acetate)-poly(vinyl alcohol) copolymer.

5. The thermal destruction reservoir of claim 1, wherein said potassium perchlorate is present in said sheet at a level of 69.0% (wt.) or higher, iron is present at a level of 15.0% (wt.)+/−5.0% (wt.) and the polymeric binder is present at a level of 16.0% (wt.)+/−5.0% (wt.).

6. The thermal destruction reservoir of claim 1, wherein said iron has a particle size in the range of 5.0 microns to 20.0 microns.

7. The thermal destruction reservoir of claim 1, wherein said sheet comprising potassium perchlorate and iron dispersed in a polymeric binder has a thickness in the range of 1.0 cm to 5.0 cm.

8. The thermal destruction reservoir of claim 1, wherein said clay coating has a thickness in the range of 0.25 inches to 2.0 inches.

9. The thermal destruction reservoir of claim 2, wherein said clay coating inner surface in contact with said at least one sheet has a thickness in the range of 0.20 inches to 0.30 inches.

10. The thermal destruction reservoir of claim 2, wherein 50% or more of said surface of said sheet is in contact with said clay coating inner surface.

11. The thermal destruction reservoir of claim 1, including one or more clips that retain the perimeter mating surfaces in contact with one another.

12. The thermal destruction reservoir of claim 11, wherein said one or more clips have one or more openings.

13. The thermal destruction reservoir of claim 1, wherein said upper and lower section are joined by a hinge and said perimeter mating surfaces include one or a plurality of screw and nut closing hardware components.

14. The thermal destruction reservoir of claim 1, wherein said thermal destruction reservoir is in the shape of a rectangular prism, cube, cylinder, pyramid, cone, or triangular prism.

15. A thermal destruction reservoir, comprising:
an upper and lower section having one or a plurality of wall portions wherein said upper and lower section each include one or more perimeter mating surfaces and an internal volume encased by said upper and lower sections when said perimeter mating surfaces are engaged to one another;
at least one sheet comprising potassium perchlorate and iron dispersed in a polymeric binder located within said reservoir internal volume wherein said binder comprises poly(vinyl acetate) and poly(vinyl acetate)-poly(vinyl alcohol) copolymer, said potassium perchlorate is present in said sheet at a level of 69.0% (wt.) or higher, iron is present at a level of 15.0% (wt.)+/−5.0% (wt.) and the polymeric binder is present at a level of 16.0% (wt.)+/−5.0% (wt.).

16. A method of thermal destruction of selected chemical and/or biological materials comprising:
providing a thermal destruction reservoir comprising an upper and lower section having one or a plurality of wall portions wherein said upper and lower section each include one or more perimeter mating surfaces and an internal volume encased by said upper and lower sections when said perimeter mating surfaces are engaged to one another;
forming a sheet by combining potassium perchlorate, iron powder and polymer binder at a temperature of less than or equal to 35° C.; and
positioning said sheet within said internal volume of said thermal destruction reservoir.

17. The method of claim 16, further including placement of an electrical ignition system in said sheet.

18. The method of claim 16, wherein said sheet has a surface and all or a portion of said sheet surface is in contact with said clay coating inner surface.

19. The method of claim 16, wherein said polymer binder comprises poly(vinyl acetate) and poly(vinyl acetate)-poly(vinyl alcohol) copolymer.

20. The method of claim 16, wherein said potassium perchlorate is present in said sheet at a level of 69.0% (wt.) or higher, iron is present at a level of 15.0% (wt.)+/−5.0% (wt.) and the polymeric binder is present at a level of 16.0% (wt.)+/−5.0% (wt.).

21. The method of claim 16, wherein said thermal destruction reservoir is in the shape of a rectangular prism, cube, cylinder, pyramid, cone or triangular prism.
